(19) United States
(12) Patent Application Publication
(10) Pub. No.: US 2023/0121817 A1
(43) Pub. Date: Apr. 20, 2023

(54) Covers Utilizing Recycled Polyester Fibers

(71) Applicant: Berry Global, Inc., Evansville, IN (US)

(72) Inventor: Paul Stuart Wormald, Essex (GB)

(21) Appl. No.: 17/966,098

(22) Filed: Oct. 14, 2022

Related U.S. Application Data
(60) Provisional application No. 63/256,058, filed on Oct. 15, 2021.

(51) Int. Cl. D04H 1/4382; D04H 1/435; D04H 1/54; D04H 1/485; D04H 1/49; A01G 13/02

(52) U.S. Cl. CPC D04H 1/43835; D04H 1/435; D04H 1/54; D04H 1/485; D04H 1/49; A01G 13/02; D10B 2505/18; D10B 2401/02; A01F 2015/0745

(57) ABSTRACT

Covers comprising a nonwoven fabric including a plurality of recycled polyester fibers, such as a plurality of staple fibers, is provided. The plurality of recycled polyester fibers may be formed from a post-consumer polyester, a post-industrial waste polyester, or a combination thereof. The covers provide desirable vapor transmission while also providing an improved hydrostatic head. The covers may be provided in a variety of configurations. Methods of forming such covers are also provided.

### CROSS-REFERENCE TO RELATED APPLICATIONS

This application claims priority under 35 U.S.C. § 119 to U.S. Patent Application No. 63/256,058 filed Oct. 15, 2021, which is being expressly incorporated by reference herein in its entirety.

### TECHNICAL FIELD

Embodiments of the presently-disclosed invention relate generally to covers (e.g., crop covers) comprising a nonwoven fabric including a plurality of recycled polyester fibers, such as a plurality of staple fibers, is provided. The covers provide desirable vapor transmission while also providing an improved hydrostatic head. Embodiments of the presently-disclosed invention also relate generally to methods of forming such covers are also provided.

### BACKGROUND

Crop covers, such as bale covers, are routinely used in an attempt to shield, at least partially, from inclement weather, such as rain and snow. In this regard, crop covers would ideally mitigate or prevent the formation of moisture buildup on or within the baled and/or stored material (e.g., hay, straw, root vegetables, wood chips, bark, etc.), which can lead to the undesirable growth of mold and/or bacteria.

Certain current approaches to the formation crop covers utilizes fabrics formed from polyolefin materials, such as polypropylene. Considering the number of crop covers in use on an annual basis, the use of numerous polyolefin-based crop covers requires the continual manufacturing of such crop covers with virgin resin (e.g., virgin polypropylene) while the crop covers are often times burned or placed in a landfill after use.

There remains a need in the art for an alternative and more environmentally conscious approach to the formation and use of crop covers, such as bale covers.

### SUMMARY OF INVENTION

One or more embodiments of the invention may address one or more of the aforementioned problems. Certain embodiments according to the invention provide covers (e.g., crop covers including hay bale cover, straw bale cover, root vegetable cover, wood chips cover, bark cover, etc.) comprising a nonwoven fabric including a plurality of recycled polyester fibers, such as a plurality of staple fibers, is provided. The plurality of recycled polyester fibers may be formed from a post-consumer polyester, a post-industrial waste polyester, or a combination thereof. The covers (e.g., crop covers) provide desirable vapor transmission while also providing an improved hydrostatic head. In this regard, the covers in accordance with certain embodiments of the invention provide a breathable cover that may also be water resistant and/or water repellent (e.g., increased hydrostatic head).

In another aspect, the present invention provides a method of forming a cover. The method may include the following: (i) providing or forming a plurality of recycled polyester staple fibers; (ii) forming a dry laid web of the plurality of recycled polyester staple fibers; (iii) cross-lapping the dry laid web upon itself to form a cross-lapped web; and (iv) consolidating the cross-lapped web to provide a cover, such as those described and disclosed herein.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The term “recycled polyester fibers”, as used herein, may comprise man-made fibers produced from polyester pre-consumer waste, polyester post-consumer waste and/or polyester post-industrial waste. In this regard, instead of utilizing new resin (e.g., virgin resin) to form the fibers (e.g., petroleum), recycled polyester fibers are produced from existing plastic (e.g., discarded water bottles). The use of recycled polyester lowers its environmental impact versus virgin polyester. Recycled polyester, for instance, reduces reliance on virgin petroleum as a raw material and diverts used plastic from landfills.

The term “pre-consumer waste”, as used herein, may comprise plastic (e.g., polyester) that has been recovered from the consumer supply chain, for example, from beverage bottles, which have expired or never consumed. The plastic (e.g., polyester) may be recycled and then ground and processed as a polyester staple fiber feedstock (e.g., recycled polyester fibers).

The term “post-consumer waste”, as used herein, may comprise plastic (e.g., polyester) that has been recovered from the consumer supply chain, for example, from beverage bottles, which are recycled and then ground and processed as a polyester staple fiber feedstock (e.g., recycled polyester fibers).

The term “post-industrial waste”, as used herein, may comprise plastic (e.g., polyester) that is generated during a manufacturing process of upstream polyester and plastic products. Non-limiting examples of such manufacturing processes can be from virgin fiber producers, tire cord manufacturers, polymerization plants, and other plastic products.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process.

The terms “fabric” and “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., needle-punching or hydroentanglement) as merely a few examples. Such a web may be considered a “consolidated nonwoven”, “nonwoven fabric” or simply as a “fabric” according to certain embodiments of the invention.

The term “staple fiber”, as used herein, may comprise a cut fiber from a filament. In accordance with certain embodiments, any type of filament material may be used to form staple fibers. For example, staple fibers may be formed from polymeric fibers, and/or elastomeric fibers. Non-limiting examples of materials may comprise polyolefins (e.g., a polypropylene or polypropylene-containing copolymer), polyethylene terephthalate, and polyamides. The average length of staple fibers may comprise, by way of example only, from about 0.5 centimeters (cm) to about 20 cm, such as about any of the following: 0.5, 1, 2, 3, 4, 5, 6, 7, 8, 9, and 10 cm, and/or at most about any of the following: 20, 19, 18, 17, 16, 15, 14, 13, 12, 11, and 10 cm.

The term “layer”, as used herein, may comprise a generally recognizable combination of similar material types and/or functions existing in the X-Y plane.

The term “monocomponent fibers”, as used herein may comprise fibers formed from a single polymer or polymeric blend (e.g., a blend or mixture of two or more polymers) extruded from a single extruder. The single polymer or polymeric blend, for example, may define a polymeric matrix in which one or more additives (e.g., fillers) may be dispersed.

The term “machine direction” or “MD”, as used herein, comprises the direction in which the fabric produced or conveyed. The term “cross-direction” or “CD”, as used herein, comprises the direction of the fabric substantially perpendicular to the MD.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

In one aspect, the present invention provides covers (e.g., hay bale cover, straw bale cover, root vegetable cover, wood chips cover, bark cover, etc.) comprising a nonwoven fabric including a plurality of recycled polyester fibers, such as a plurality of staple fibers, is provided. The plurality of recycled polyester fibers may be formed from a pre-consumer polyester, a post-consumer polyester, a post-industrial waste polyester, or a combination thereof. The covers provide desirable vapor transmission while also providing an improved hydrostatic head. In this regard, the covers in accordance with certain embodiments of the invention provide a breathable cover that may also be water resistant and/or water repellent (e.g., increased hydrostatic head). In accordance with certain embodiments of the invention, the plurality of recycled polyester fibers comprise a recycled polyester terephthalate (rPET).

In accordance with certain embodiments of the invention, the nonwoven fabric and/or cover may have a basis weight from about 20 to about 500 gsm, such as at least about any of the following: 20, 50, 80, 90, 100, 120, 140, 160, 180, 200, 220, 240, and 250 gsm, and/or at most about any of the following: 500, 480, 460, 440, 420, 400, 380, 360, 340, 320, 300, 280, 260, and 250 gsm. Additionally or alternatively, the nonwoven fabric may have a thickness in the z-direction, which is perpendicular to the cross-direction (CD) and the machine-direction (MD), that is from about 0.25 mm to about 20 mm, such as at least about any of the following: 0.25, 0.5, 0.75, 1, 3, 5, 6, 8, an 10 mm, and/or at most about any of the following: 20, 18, 16, 15, 14, 12, and 10 mm.

As noted above, the plurality of recycled polyester fibers comprises a plurality of staple fibers. In accordance with certain embodiments of the invention, the plurality of staple fibers comprise an average length from about 0.5 centimeters (cm) to about 20 cm, such as about any of the following: 0.5, 1, 2, 3, 4, 5, 6, 7, 8, 9, and 10 cm, and/or at most about any of the following: 20, 19, 18, 17, 16, 15, 14, 13, 12, 11, and 10 cm. Additionally or alternatively, the plurality of staple fibers may comprise a blend of a first plurality of staple fibers having a first average length and a second plurality of staple fibers having a second average length, wherein the first average length is less than the second average length. For example, the blend of the first plurality of staple fibers and the second plurality of staple fibers may have a bimodal distribution of average fiber lengths. Additionally or alternatively, the first average length may range from about 0.5 to about 5 cm, such as at least about any of the following: 0.5, 1, 1.5, and 2.5 cm, and/or at most about any of the following: 5, 4.5, 4, 3.5, 2, and 2.5 cm; and the second average length may range from about 8 to about 20 cm, such as at least about any of the following: 8, 10, 12, 14, and 15 cm, and/or at most about any of the following: 20, 19, 18, 17, 16, and 15 cm.

In accordance with certain embodiments of the invention, the plurality of staple fibers may comprise an average diameter from about 5 microns to about 30 microns, such as at least about any of the following: 5, 6, 8, 10, 12, 14, 15, 16, and 17 microns, and/or at most about any of the following: 30, 28, 26, 25, 24, 22, 20, 19, 18, and 17 microns.

The nonwoven fabric, in accordance with certain embodiments of the invention, may comprise a plurality of mechanical bonds between the plurality of staple fibers, wherein the plurality of staple fibers are physically entangled and/or interlocked with each other. The plurality of mechanical bonds, for example, may be formed by a hydroentanglement operation, needle-punching operation, or a combination thereof. Additionally or alternatively, the nonwoven fabric may comprise one or more thermal bond sites.

In accordance with certain embodiments of the invention, the one or more thermal bond sites may comprise a plurality of individual thermal bond sites defining a thermal bonded pattern. The thermal bonded pattern, for example, may define a thermal bonded area from about 3 to about 40%, such as at least about any of the following: 3, 5, 6, 8, 10, 12, 14, 15, 16, 18, and 20%, and/or at most about any of the following: 40, 38, 36, 35, 34, 32, 30, 28, 26, 25, 24, 22, and 20%.

In accordance with certain embodiments of the invention, the one or more thermal bond sites may comprise a single or contiguous thermal bond site forming an area bonded nonwoven fabric. For example, the single or contiguous thermal bond site may comprise 100% (e.g., a 100% bond area). The contact area between the pre-thermally bonded material (e.g., the pre-thermally bonded material may already be at least lightly consolidated via mechanical means as discussed herein) and the calendar (e.g., a smooth calendar to provide uniform bonding across the entire surface thereof) for bonding may be 100% to provide an area bonded nonwoven fabric. The area bonded nonwoven fabric, for example, may comprise at least a portion of the plurality of fibers having a deformed shape due to the partial softening and at least partially flowing of the plurality of fibers to partially fill interstitial voids between the fibers at an outermost surface of the nonwoven fabric to form or define a microporous film structure on the outermost surface of the nonwoven fabric. In this regard, the microporous film structure may resemble a film structure with a plurality of micro-channels or micro-pores therein, which maintain the breathability of the nonwoven fabric while facilitating resistance to penetration by water.

In accordance with certain embodiments of the invention, the plurality of recycled polyester fibers account for about 20% to about 100% by weight of a total fiber amount of the nonwoven fabric, such as at least about any of the following: 20, 30, 40, 50 and 60%, and/or at most about any of the following: 100, 98, 95, 92, 90, 85, 80, 75, 70, 65, and 60%. In this regard, the total fiber amount or content of the nonwoven fabric may entirely be attributed to the plurality of recycled polyester fibers (i.e., 100% recycled polyester fibers). Alternatively, the nonwoven fabric may optionally include fibers formed from a virgin polyester and/or fibers formed from a polyolefin.

The plurality of recycled polyester fibers, in accordance with certain embodiments of the invention, may comprise a hydrophobic additive disposed on at least a portion of an outer surface of the plurality of recycled polyester fibers and/or disposed within the melt forming the plurality of recycled polyester fibers. Additionally or alternatively, the plurality of recycled polyester fibers may comprise one or more additives, such as an organic filler, an inorganic filler, a hydrophobic additive, an antimicrobial agent, ultraviolet stabilizers, a herbicide, a bactericide, a fungicide, a deodorizer, or any combination thereof. Such additives, for example, may be topically applied as an outermost coating on the plurality of recycled polyester fibers and/or disposed with in the melt used for forming the plurality of recycled polyester fibers.

In accordance with certain embodiments of the invention, the nonwoven fabric has a moisture vapor transmission rate of at least about 500 grams/m²/24 hours according to BS 7209, such as at least about any of the following: 500, 520, 540, 560, 580, 600, 615, and 620 grams/m²/24 hour according to BS 7209, and/or at most about any of the following: 1000, 950, 900, 850, 800, 750, 725, 700, 675, 650, 640, 630, and 620 grams/m²/24 hours according to BS 7209. Additionally or alternatively, the nonwoven fabric may have a hydrostatic head of at least about 60 mm according to EN ISO 20811, such as at least about any of the following: 60, 80, 100, 120, 140, 150, 160, 170, 180, 190, and 200 mm according to EN ISO 20811, and/or at most about any of the following: 250, 240, 230, 220, 210, and 200 mm according to EN ISO 20811.

In accordance with certain embodiments of the invention, the cover or nonwoven fabric may comprise a rectangular or square geometry. In this regard, the cover may comprise a tarp, which may be draped over and/or secured over one or more bales or bundles of material (e.g., straw, hay, root vegetables, wood chips, bark, etc.). Alternatively, the cover or nonwoven fabric may comprise a three-dimensional structure comprising a rectangular prism or a cube having a top portion located between and attached to four side portions, in which the three-dimensional structure is open or includes an opening at a bottom portion opposite to the top portion. The top portion and each of the four side portions may comprise respective portions of the nonwoven fabric (e.g., a single piece or a plurality of pieces that have been stitched and/or bonded together to define the structure). In accordance with certain embodiments of the invention, the cover has a three-dimensional structure comprising a cylindrical configuration having a first end portion having a first circular geometry, a second end portion having a second circular geometry, and an intermediate portion located between and attached to both of the first end portion and the second and portion. The first end portion, the second end portion, and the intermediate portion may comprise respective portions of the nonwoven fabric (e.g., a single piece or a plurality of pieces that have been stitched and/or bonded together to define the structure). In accordance with certain embodiments of the invention, the cover or nonwoven fabric may be configured to completely overwrap or encapsulate one or more bales and/or bundles of material.

In accordance with certain embodiments of the invention, the cover may comprise one or more strap portions attached to the nonwoven fabric. For example, the one or more strap portions may be stitch-bonded, adhesively bonded, and/or thermally bonded to the nonwoven fabric at a first end or respective first ends. The one or more strap portions, for instance, may be configured to releasable attach to a portion of the nonwoven fabric at a second end or respective second ends of the one or more strap portions. For example only, the one or more strap portions may each include a section having a plurality of hook elements, such as those used in a hook-and-loop attachment system, configured to releasably engage with the portion of the nonwoven fabric. Additionally or alternatively, the one or more strap portions may be configured to releasably engage with one or more ground stakes. For example, the second end or respective second ends of the one or more strap portions may include a looped section that may be engaged or retained by a ground stake (e.g., a portion of the ground stake may pass through the looped section).

In another aspect, the present invention provides a method of forming a cover. The method may include the following: (i) providing or forming a plurality of recycled polyester staple fibers; (ii) forming a dry laid web of the plurality of recycled polyester staple fibers; (iii) cross-lapping the dry laid web upon itself to form a cross-lapped web; and (iv) consolidating the cross-lapped web to provide a cover, such as those described and disclosed herein.

In accordance with certain embodiments of the invention, the step of cross-lapping the dry laid web upon itself to form a cross-lapped web may comprise forming a cross-lapped web having from about 2 to about 20 layers, such as at least about 2, 4, 6, 8, 10, and 12 layers, and/or at most about any of the following: 20, 18, 16, 14, and 12 layers. In accordance with certain embodiments of the invention, the cross-lapped web may have a first layer oriented in a first direction (e.g., 0 degrees as a reference) and a second layer oriented in a second direction, in which the second direction is offset from the first direction by an angle of from about 10 degrees to about 90 degrees, such as at least about any of the following: 10, 15, 20, 25, 30, 35, 40 and 45 degrees, and/or at most about 90, 85, 80, 75, 70, 65, 60, 55, 50, and 45 degrees. In accordance with certain embodiments of the invention, the first layer and the second layer are adjacent to each other.

In accordance with certain embodiments of the invention, the step of consolidating the cross-lapped web may comprise subjecting the cross-lapped web to a needle-punching operation, a hydroentanglement operation, or both. Additionally or alternatively, consolidating the cross-lapped web may comprise subjecting the cross-lapped web to a thermal bonding operation, ultrasonic bonding operation, an adhesive bonding operation, or any combination thereof In accordance with certain embodiments of the invention, the step of consolidating the cross-lapped web comprises (i) subjecting the cross-lapped web to a needle-punching operation followed by (ii) subjecting the cross-lapped web to a thermal bonding operation, a ultrasonic bonding operation, or both. In this regard, the nonwoven fabric include both mechanical bonds and thermal bonds.

In accordance with certain embodiments of the invention, the method may further comprise forming a three-dimensional structure from the nonwoven fabric. For example, the three-dimensional structure may comprise a rectangular prism or a cube having a top portion located between and attached to four side portions. The three-dimensional structure may be open at a bottom portion opposite to the top portion or alternatively include an opening to ease in covering or encapsulating a bale and/or bundle of material. A perimeter defined by a portion of a bottom portion (e.g., also formed from the nonwoven fabric) or a perimeter defined by the four side portions may optionally include a draw string of the like for cinching, reducing, and/or closing the opening toward itself after being positioned over a bale and/or bundle of material. In accordance with certain embodiments of the invention, the top portion and each of the four side portions may be formed from respective portions of the nonwoven fabric either as a contiguous pieces or as a plurality of separate pieces of the nonwoven fabric that has been attached and/or bonded together in a manner to form the three-dimensional structure. For example, separate pieces of the nonwoven fabric (e.g., pieces of the nonwoven fabric cut to the desired shape and/or dimensions) may be stitched together and or bonded together (e.g., thermally bonded and/or adhesively bonded) together to form the three-dimensional structure.

In accordance with certain embodiments of the invention, the three-dimensional structure may comprise a cylindrical configuration having a first end portion having a first circular geometry, a second end portion having a second circular geometry, and an intermediate portion located between and attached to both of the first end portion and the second end portion. In accordance with certain embodiments of the invention, the intermediate portion may comprise an opening that may facilitate the covering and/or encapsulation of a bale and/or bundle of material with the cover. A perimeter of the intermediate section may define the opening and may optionally include a draw string of the like for cinching, reducing, and/or closing the opening toward itself after being positioned over a bale and/or bundle of material. The opening may alternatively be defined by the first end portion, the second end portion, and the intermediate portion, while optionally also including the draw string or the like. In accordance with certain embodiments of the invention, first end portion, the second end portion, and the intermediate portion may be formed from respective portions of the nonwoven fabric either as a contiguous pieces or as a plurality of separate pieces of the nonwoven fabric that has been attached and/or bonded together in a manner to form the three-dimensional structure. For example, separate pieces of the nonwoven fabric (e.g., pieces of the nonwoven fabric cut to the desired shape and/or dimensions) may be stitched together and or bonded together (e.g., thermally bonded and/or adhesively bonded) together to form the three-dimensional structure.

In accordance with certain embodiments of the invention, the method may further comprise attaching one or more strap portions to the nonwoven fabric. For example, the one or more strap portions may be stitch-bonded, adhesively bonded, and/or thermally bonded to the nonwoven fabric at a first end or respective first ends. The one or more strap portions, for instance, may be configured to releasable attach to a portion of the nonwoven fabric at a second end or respective second ends of the one or more strap portions. For example only, the one or more strap portions may each include a section having a plurality of hook elements, such as those used in a hook-and-loop attachment system, configured to releasably engage with a portion of the nonwoven fabric. Additionally or alternatively, the one or more strap portions may be configured to releasably engage with one or more ground stakes. For example, the second end or respective second ends of the one or more strap portions may include a looped section that may be engaged or retained by a ground stake (e.g., a portion of the ground stake may pass through the looped section).

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A cover, comprising a nonwoven fabric comprising a plurality of recycled polyester fibers; wherein the plurality of recycled polyester fibers comprise a pre-consumer waste, a post-consumer polyester, a post-industrial waste polyester, or a combination thereof

2. The cover of claim 1, wherein the plurality of recycled polyester fibers comprise a recycled polyester terephthalate (rPET).

3. The cover of claim 1, wherein the plurality of recycled polyester fibers comprises a plurality of staple fibers.

4. The cover of claim 3, wherein the plurality of staple fibers comprise an average length from about 0.5 centimeters (cm) to about 20 cm.

5. The cover of claim 3, wherein the plurality of staple fibers comprise a blend of a first plurality of staple fibers having a first average length and a second plurality of staple fibers having a second average length, wherein the first average length is less than the second average length.

6. The cover of claim 5, wherein the first average length ranges from about 0.5 to about 5 cm and the second average length ranges from about 8 to about 20 cm.

7. The cover of claim 3, wherein the plurality of staple fibers comprise an average diameter from about 5 microns to about 30 microns.

8. The cover of claim 3, wherein the nonwoven fabric comprises a plurality of mechanical bonds between the plurality of staple fibers, wherein the plurality of staple fibers are physically entangled with each other.

9. The cover of claim 8, wherein the nonwoven fabric further comprises one or more thermal bond sites.

10. The cover of claim 9, wherein the one or more thermal bond sites comprises a plurality of individual thermal bond sites defining a thermal bonded pattern.

11. The cover of claim 10, wherein the thermal bonded pattern defines a thermal bonded area from about 3 to about 40%.

12. The cover of claim 10, wherein the one or more thermal bond sites is a single thermal bond site of a bond area of 100% forming an area bonded nonwoven fabric.

13. The cover of claim 12, wherein at least a portion of the plurality of fibers has softened and at least partially flowed to forma microporous film structure on the outermost surface of the nonwoven fabric.

14. The cover of claim 1, wherein the plurality of recycled polyester fibers account for about 20% to about 100% by weight of a total fiber amount of the nonwoven fabric.

15. The cover of claim 1, wherein the nonwoven fabric has a moisture vapor transmission rate of at least about 500 grams/m²/24 hours according to BS 7209, a hydrostatic head of at least about 60 mm according to EN ISO 20811, or both.

16. The cover of claim 1, wherein the cover at least partially encapsulates a crop, wherein the crop comprises hay, straw, root vegetables, wood chips, bark, or any combination thereof

17. A method of forming a cover, comprising:
(i) providing or forming a plurality of recycled polyester staple fibers;
(ii) forming a dry laid web of the plurality of recycled polyester staple fibers;
(iii) cross-lapping the dry laid web upon itself to form a cross-lapped web; and
(iv) consolidating the cross-lapped web to provide a cover.

18. The method of claim 17, wherein the cross-lapped web has from about 2 to about 20 layers, and wherein the cross-lapped web has a first layer oriented in a first direction and a second layer oriented in a second direction, wherein the second direction is offset from the first direction by an angle of from about 10 degrees to about 90 degrees.

19. The method of claim 17, wherein consolidating the cross-lapped web comprises subjecting the cross-lapped web to needle-punching operation, a hydroentanglement operation, or both.

20. The method of claim 19, wherein consolidating the cross-lapped web further comprises subjecting the cross-lapped web to a thermal bonding operation, ultrasonic bonding operation, an adhesive bonding operation, or any combination thereof
